(19) United States
(12) Patent Application Publication
(10) Pub. No.: US 2013/0044182 A1
(43) Pub. Date: Feb. 21, 2013

(54) APPARATUS AND METHOD TO IMPLEMENT A RADIO-FREQUENCY (RF) 3D IMAGING SYSTEM

(71) Applicant: Chen-Tai Chen, Tao Yuan (TW)

(72) Inventor: Chen-Tai Chen, Tao Yuan (TW)

(21) Appl. No.: 13/587,285

(22) Filed: Aug. 16, 2012

(30) Foreign Application Priority Data
Aug. 17, 2011 (CN) 201110236778.9
Nov. 22, 2011 (TW) 100142809

(51) Int. Cl. H04N 13/00

(52) U.S. Cl. 348/42; 348/E13.073

(57) ABSTRACT

An apparatus and method are disclosed to implement a radio-frequency (RF) 3D imaging system. In one embodiment, the method includes searching and analyzing signals emitted from emitters external to the 3D glasses to determine a strongest RF (Radio Frequency) signal source. The method also includes reading and storing an identification code of the strongest RF signal source. The method further includes receiving synchronization signals from an emitter that emits the strongest RF signal. In addition, the method includes synchronizing and controlling the 3D glasses based on the synchronization signals.

### CROSS-REFERENCE TO RELATED APPLICATIONS

The present application for patent claims the benefit of Taiwan Patent Application No. 100142809, filed on Nov. 22, 2011, and China Patent Application No. 201110236778.9, filed on Aug. 17, 2011.

### FIELD

This disclosure relates generally to an apparatus and method to implement a radio-frequency (RF) 3D (3-Dimensional) image system.

### BACKGROUND

3D movies have become popular in recent years, putting 3D films and content in high demand and causing the 3D products to transform from just for the movies to a 3D display industry (for example: 3D TV). Humans could see the depth of the objects and the stereo pictures through visual perception called “depth perception.” With depth perception, users could judge the corresponding positions of objects in 3D space. Users' eyes are typically not in the same positions. The distance between two eyes is normally about five to seven centimeters. Therefore, as users see the binocular parallax, their brains will merge the images and create the sense of stereo pictures (or binocular cues). Further, human eyes could judge the distance of the object by accommodating the focus of the object in different distance by motion parallax, by perspective or by light. Humans could also use only one eye to determine the distance of the object. Therefore, to transform a 2D image into a 3D image, the right and left eyes have to see different images or pictures (i.e., binocular parallax), and the brain would merge the different images or pictures to form the 3D picture.

Currently, shutter glasses or lenses are typically used. The basic principle of shutter glasses is that images for the right and left eyes are displayed alternately on the screen at about doubled frequency rate, and the glasses will automatically cover the user's right and left eyes separately. The right eye is covered when the picture for the left eye is displayed on the screen, monitor, or television, and the left eye is covered when the picture for the right eye is displayed such that the two eyes receive and see two separate pictures. Although, the two eyes cannot watch the images or pictures at the same time, through the effect of human eyes temporary persisting vision, the user would still have the sense that he is watching the pictures simultaneously, thereby generating the stereo image.

The available 3D screens, monitors or televisions typically encode the 3D images with particular communication protocols, and the encoded signals are conveyed to the 3D glasses receiver by an emitter. After decoding the encoded signals received by the 3D receiver, the 3D glasses could process the image signals and turn the shutter glasses or lenses on/off according to the image signals.

Currently, the signals of the 3D glasses are transmitted and received through certain protocols (such as Bluetooth, Zigbee, etc.). However, the Bluetooth protocol, for example, needs more data and longer emitting time, and could be easily to be interfered with by other signals. Also, the Bluetooth protocol needs a special operation to achieve synchronization and transmission over a shorter distance.

### SUMMARY

An apparatus and method are disclosed to implement a radio-frequency (RF) 3D imaging system. In one embodiment, the method includes searching and analyzing signals emitted from emitters external to the 3D glasses to determine a strongest RF (Radio Frequency) signal source. The method also includes reading and storing an identification code of the strongest RF signal source. The method further includes receiving synchronization signals from an emitter that emits the strongest RF signal. In addition, the method includes synchronizing and controlling the 3D glasses based on the synchronization signals.

### BRIEF DESCRIPTION OF THE DRAWINGS

FIG. 1 shows an exemplary embodiment of the 3D glasses.

FIG. 2 shows an illustrative functional block diagram of the controller module according to one embodiment of the invention.

FIG. 3 shows another illustrative functional block diagram of the controller module according to one embodiment of the invention.

FIG. 4 is an exemplary flow chart diagram that generally illustrates the processes involved in the RF communication method according to one embodiment of the invention.

FIG. 5 shows exemplary waveforms according to one embodiment of the invention.

FIGS. 6A and 6B pertain to the detection of the position or posture of the 3D glasses according to one embodiment of the invention.

### DETAILED DESCRIPTION

In general, in one embodiment, the present invention provides a RF communication method for 3D glasses that includes: searching the signal sources; determining which signal source has the strongest RF signal; reading the identification codes of the strongest RF signal; receives the parameters sent by the emitter that generates the strongest RF signal; and optimizing and synchronizing control of the 3D glasses based on the received parameters. In this embodiment, the present invention provides a controller module for the 3D glasses. Through the controller module, the 3D glasses could respond quickly to the RF signals and parameters to allow precise matching between the 3D glasses and display screen.

In another embodiment, the 3D glasses has a controller module that includes: a signal receiver module to receive external RF signals and parameters; a glasses driving module to open and close (i.e., to turn on or off) the shutter lenses of the 3D glasses; a boost circuit to output the power to glasses driving module; and one main control chip module that includes a RF chip. In this embodiment, the main control chip module (1) controls the RF chip to accurately receive the RF signals, (2) outputs instructions to the glasses driving module and the boost circuit, and (3) controls the boost circuit to provide power for glasses driving module. When the RF chip receives parameters, the main control chip module would output corresponding instructions to glasses driving module according to the received parameters, and would switches the boost circuit on to provide working power for glasses driving module. At the same time, the main control chip would turn on the boost circuit to provide power to the glasses driving module. In turn, the glasses driving module would turns the left shutter lens and right shutter lens on/off. As a result, the 3D glasses and display screen would be matched and synchronized precisely to achieve maximal 3D effect.

In one embodiment, the 3D glasses would receive RF signals emitted by the nearest 3D apparatus in RF mode. Therefore, signal interferences from other 3D apparatus could be avoided. In this embodiment, the 3D glasses have the following characteristics: low power consumption, automatic and simple synchronization process, good anti-interference, and capable of supporting a longer transmission distance.

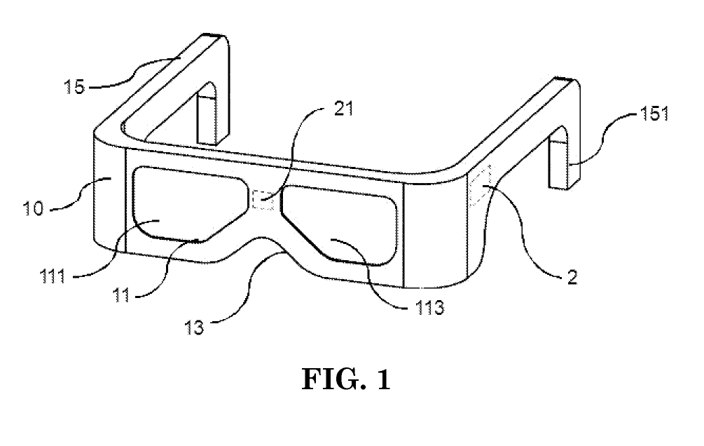

FIG. 1 shows an exemplary embodiment of the 3D glasses. As shown in FIG. 1, the 3D glasses include a frame 11 with a lens holder 10. The glasses frame 11 has a left lens, 113 and a right lens 111. The nose piece 13 is in the middle of the glasses frame 11. A pair of arms or temples 15 is connected to the sides of the lens holder 10, and also forms an ear frame 151 at the end. In one embodiment, the signal receiver 21 is placed in the glasses frame between the lens holders 10, and is used to turn the right lens 111 and left lens 113 on or off. Alternatively; the signal receiver module 21 could also be placed in the other places of the glasses frame 11 or in the left or right of the 3D glasses. The controller module 2 is placed in the lens holder 10. However, the controller module 2 could also be placed to the right or left side of lens holder 10.

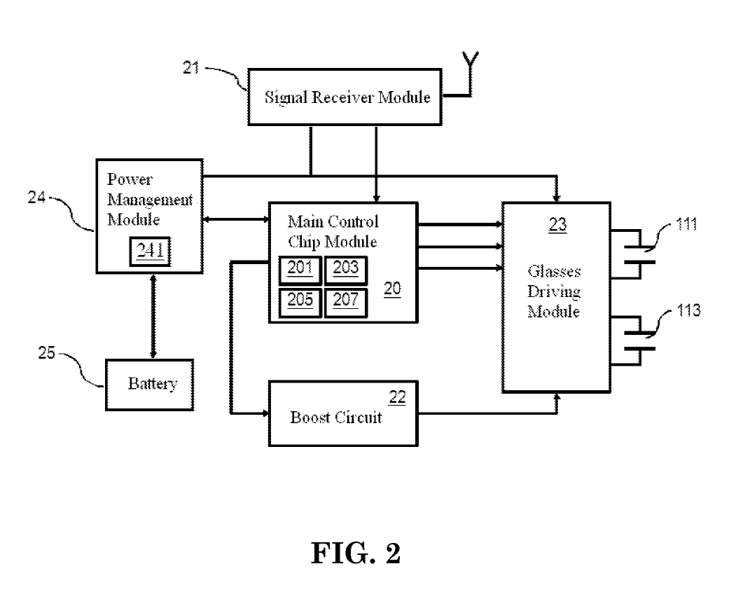

FIG. 2 shows an illustrative functional block diagram of the controller module in one embodiment of the 3D glasses. As shown in FIG. 2, the controller module 2 of the 3D glasses 1 includes: a signal receiver module 21 used to receive the identification codes of RF signals and parameters from outside signal sources; a boost circuit 22 that provides the power to controller module 2; a glasses driving module 23, with one side connected to boost circuit 22, used to turn the LCD shutter lens in the right lens 111 and left lens 113 on or off; and the main control chip module 20 that is connected to signal receiver module 21 on one end and to glasses driving module 23 on the other end.

In one embodiment, the 3D synchronization signal is emitted and transmitted to the glasses in accordance to the rising edge of V-sync. Table 1 below illustrates an exemplary structure of the 3D synchronization signal. In Table 1, each “#” represents a hexadecimal value.

TABLE 1

| | | ID | | | |
|---|---|---|---|---|---|
| | | Manufacturer's | Manufacturer's | | |
| SC | DL | ID0 | ID1 | ID0 | ID1 |
| 0x## | 0x05 | 0x## | 0x## | 0x## | 0x## |

As seen in Table 1 above, the 3D synchronization signal includes at least the following fields or components:

Starting Code (SC)—In one embodiment, the Starting Code field could be a 1-byte value that represents the starting header of the RF identification codes and a specially designed code will be adopted to express the SC. The synchronization signal could be determined based on the Starting Code.

Data Length (DL)—In one embodiment, the Data. Length field could be one (1) byte in length, and represents the length of the data portion of the synchronization signal.

Identification (ID)—In one embodiment, the ID field could be four (4) bytes in length. The first two (2) bytes are for the manufacturer ID codes, and the next two (2) bytes are for the RF identification codes. In general, each television would have a unique ID code. In one embodiment, the value of each two-byte ID codes (the manufacturer ID code as well as the RF ID code) would be incremented to denote different pieces of 3D equipment made by different manufacturers. In this embodiment, when the value of the ID codes is over 65,535, the value would be reset to 0 and incremented again. In addition, when the 3D synchronization signal is emitted, V-sync would need to be identified.

Table 2 below shows an alternative structure of the 3D synchronization signal (including 3D control parameters) in accordance with an alternative embodiment. In Table 2, each “#” represents a hexadecimal value.

TABLE 2

| | | | RPT | LO | LC | RO | RC | |
|---|---|---|---|---|---|---|---|---|
| SC | DL | ID | (Times) | (μs) | (μs) | (μs) | (μs) | CS |
| 0x## | 0x10 | 0x#### | 0x08 | 0x07D0 | 0x1770 | 0x07D0 | 0x1770 | 0x#### |

In one embodiment, the 3D synchronization signals, which have the structure format shown in Table 1, are shorter signals normally emitted by emitters or other 3D equipment. In addition, the 3D synchronization signals, which have the structure format shown in Table 2, are longer signals that include 3D control parameters. Upon receipt of the longer signals (as shown in Table 2), the 3D glasses would be adjusted based on the 3D control parameters included in the signals.

As seen in Table 2 above, the exemplary structure of the 3D synchronization signal includes the following fields:

Starting Code (SC)—In one embodiment, the Starting Code field could be a 1-byte value that represents the starting header of the RF identification codes. In this embodiment, a specially designed code will be adopted to express the SC so that the starting position of the synchronization signal would be known.

Data Length (1 byte)—In one embodiment, the Data Length field could be one (1) byte in length, and is the length of the data portion of the synchronization signal.

Identification (ID)—In one embodiment, the ID field could be four (4) bytes in length. In this embodiment, the ID field is a serial number that includes the manufacturer's ID code and the RF identification code.

Repeat (RPT)—In one embodiment, the RPT field is a 1-byte value indicating how many times (0 to 255) the system should loop before receiving the synchronization signal again. In the example shown in Table 2 above, the Repeat field is set to eight (8).

Left Open (LO)—In one embodiment, the LO field could be a 2-byte value, and is used to indicate a waiting time, in microseconds (μs) that the system should wait after receiving the synchronization signal before turning on the left lens. In this embodiment, the LO field could be set to a value in the range of 0 to 65,535 μs. In the example shown in Table 2 above, the LO field is set to 2,000 μs (or 0x7D0 μs).

Left Close (LC)—In one embodiment, the LC field could be a 2-byte value, and is used to indicate a waiting time, in microseconds (μs), that the system should wait after receiving the synchronization signal before turning the left lens off. In this embodiment, the LC field could be set to a value in the range of 0 to 65,535 μs. In the example shown in Table 2, the LC field is set to 6,000 μs (or 0x1770 μs).

Right Open (RC)—In one embodiment, the RC field could be a 2-byte value, and is used to indicate a waiting time, in microseconds (μs), that the system should wait after receiving the synchronization signal before turning on the right lens. In this embodiment, the RC field could be set to a value in the range of 0 to 65,535 μs. In the example shown in Table 2, the RC field is set to 2,000 μs (or 0x07D0 μs).

Right Close (RC)—In one embodiment, the RC field could be a 2-byte value, and is used to indicate a waiting time, in microseconds (μs), that the system should wait after receiving the synchronization signal before turning off the right lens. In this embodiment, the RC field could be set to a value in the range of 0 to 65,535 μs. In the example shown in Table 2, the RC field is set to 6,000 μs (or 0x1770 μs).

Check Sum (CS)—In one embodiment, the CS field could be a Cyclical Redundancy Check (CRC) Sum that is two (2) bytes in length.

In general, the manufacturer ID code and the RF ID code are used to match or synchronize the 3D glasses with the emitter or other 3D equipment. For example, there could be multiple emitters or other pieces 3D equipment transmitting 3D signals to multiple 3D glasses in a room. Therefore, each pair of 3D glasses should be matched with a corresponding emitter or other 3D equipment so that the 3D glasses receive 3D synchronization signals from the appropriately matched or synchronized 3D equipment. The 3D glasses should ignore 3D signals from non-matched emitters or other 3D equipment.

In addition, when the 3D glasses are turned on, the glasses with automatically match or synchronize with an emitter or other 3D equipment according to the strength of the signal source. After finding a match, the 3D glasses would be automatically configured to receive 3D signals from the matched emitter or other 3D equipment.

Returning to FIG. 2, the main control chip module 20 has a RF chip 201. In one embodiment, the main control chip module 20 controls the RF chip 201 to accurately receive the RF signals, and outputs instructions to the glasses driving module 23 and the boost circuit 22 to make the glasses driving module 23 perform the corresponding tasks as needed. The boost circuit 22 to support power to glasses driving module 23. When the RF chip 201 receives the 3D control parameters, the main control chip module 20 would output corresponding instructions to glasses driving module 23, and would also switch on the boost circuit 22 to provide sufficient power to glasses driving module 23. Therefore, the glasses driving module 23 can turn the right lens 111 and left lens 113 on/off precisely at the appropriate time.

Furthermore, the controller module 2 includes a battery 25 and a power management module 24. One end of the power management module 24 is connected to battery 25; and the other end is connected to main control chip module 20 and glasses driving module 23. Thus, the power management module 24 could manage the power charging of battery 25, and could provide working power to the circuits and modules. In one embodiment, the power management module 24 includes a glasses posture detection unit 241 to detect the posture or position of the 3D glasses. When the 31 glasses are turned upside down, the 3D glasses would be switched off automatically to conserve power and extend battery life.

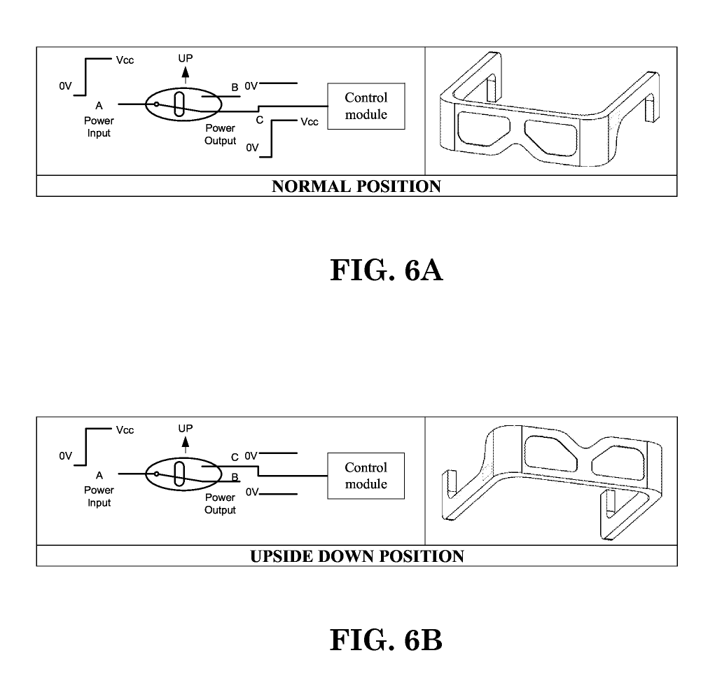

As shown in FIG. 6A, in one embodiment, when the 3D glasses and the posture detection unit is in the normal position or posture, the power of contact point A is transformed to the control module through the point C, indicating that the 3D glasses are in the normal position or posture.

However, as shown in FIG. 6B, when the 3D glasses and the posture detection unit is in the normal position or posture, the power of contact point A will not be transformed to the control module through any contact point, indicating that the 3D glasses are in an upside down position or posture. In one embodiment, when the 3D glasses are in an upside down position, the glasses will be automatically switched off.

Further, the main control chip module 20 includes a diagnostic unit 203, a storage unit 205, and an automatic switch off unit 207. In one embodiment, the diagnostic unit 203 would compare the strength of the RF signals received by signal receiver module 21 from difference external signal sources, and would decide which source emits the strongest RF signal with identification codes. In this embodiment, the diagnostic unit 203 would find the strongest RF signal with identification codes, and would store the identification codes of the strongest RF signal to storage unit 205 for subsequent identification purposes. Also, in one embodiment, if the automatic switch off unit 207 does not receive the corresponding parameters of the identification codes in the preset time, the 3D glasses would be turned off automatically.

In one embodiment, before watching a 3D program generally, the 3D glasses are worn by users would initially search signals sources from various apparatuses (e.g., TV, digital player, overhead projector, or computer, etc.). However, if multiple signals exist in the air, the 3D glasses, the controller module 2 would catch the strongest RF signal with identification codes through the diagnostic unit 203 in the main control chip module 20. After the strongest RF signal has been determined, the signal received module 21 in the controller module 2 would receive and verify the RF signal, and would then send the RF signal to RF chip 201 so that the received identification codes could be identified. After the identification process, the signal receiver module 21 would receive and process the 3D control parameters from the signal source (e.g., a 3D emitter or other 3D equipment). The received control parameters would be used to turn the LCD lens of left lens 113 and right lens 111 on or off. Left images and right images of the 3D images would be displayed alternately. Furthermore, the left and right lenses in the 3D glasses should be alternately turned on so that the 3D effect could be achieved. The parameter signals are used to control when the lens should be turned on/off.

Using a 120 Hz LED backlighting display as an example, the image renewing time is about 4: me and the image holding time is about 4.3 ms. In other words, approximately 8.3 ms would be needed to refresh a new image. Therefore, to achieve the optimal 3D effect of the images, the optimal time to turn on for both of the left, lens 113 and right lens 111 should be closer to 4.3 ms because the time duration to hold the image is typically equal to the time duration of turning on the left lens and right lens. In the period when the image should be refreshed, the LED backlighting screen should be turned off, and the left lens 113 and right lens 111 should not be shown the image on the screen.

When the timing cycle is between approximately 3.95 ms and 4 ms, the LED backlighting display should be turned on, the left lens 113 should be completely turned on, and right lens 111 should be turned off so that only the left eye can watch the image in the screen. When the timing cycle is up to 8.3 ms, both left and right lenses as well as the LED backlighting should be turned off. The screen would then go back to the status of image refreshing. At that time, the left lens 113 should be off, and the right lens 111 should be ready to start. When the timing cycle reaches between approximately 12.25 ms and 12.3 ms (i.e., about 3.94 ms to 4 ms after the left lens 113 was turned off), the LED backlighting of the screen display should be turned on. At that time, the right lens 111 should be turned on so that only the right eye could see the display. When the timing cycle reaches approximately 16 ms (i.e., about 4 ms after the right lens 111 was turned on), the right lens 111 should be turned off and returned to image refreshing status. The switching or turning on/off of the left and right lenses should be repeated as discussed above.

After the controller module 20 receives the 3D parameter signals from the desired apparatus, the main control chip module 20 would control the power management module 24 and boost circuit 22. The boost circuit 22 would provide power to glasses to drive module 23 to turn the left and right LCD lenses 113 and 111 on/off. The main control chip module 20 would also control the timing as to when the left and right LCD lenses 113 and 11 should be turned on/off in accordance with the received 3D parameter signals.

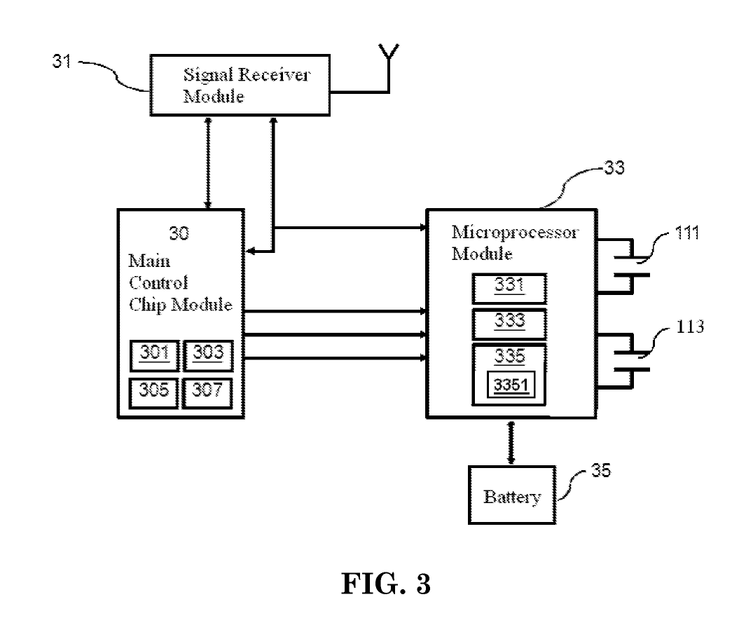

FIG. 3 shows a functional block diagram of the controller module in one embodiment. As shown in FIG. 3, the controller module 2 of the 3D glasses 1 includes: a signal receiver module 31 used to receive the RF signal and parameters from outside sources; a control chip module 30 that has one RF chip 301, and is operatively connected to signal receiver module 31; a microprocessor module 33 which is operatively connected to signal receiver module 31 at one end and to control chip module 30 at the other end. The main control chip module 30 controls the RF chip 301 to facilitate the accurate reception of the RF signals.

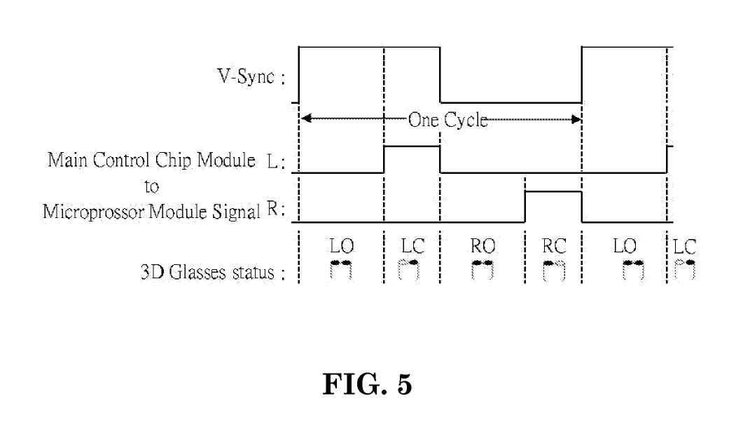

As seen in FIG. 3, the microprocessor module 33 includes: a glasses driving module 331 used to turn the LCD lenses 111 and 113 on/off and a boost circuit 333 that provides power to glasses driving module 331. In general, the main control chip module 30 sends instructional signals and control parameters to microprocessor module 33 to control the 3D glasses. FIG. 5 illustrates exemplary waveform of signals and/or parameters sent from main control chip module 30 to microprocessor module 33.

When the RF chip 301 receives control parameters, the main control chip module 30 will send corresponding instructions (in accordance with the waveform shown in FIG. 5) to microprocessor module 33 according to the received control parameters. Then, the microprocessor module 33 would drive or turn the lenses of the 3D glasses on/off at the appropriate time.

As shown in FIG. 3, the main control chip module 30 includes: a diagnosis unit 303, a storage unit 305, and an automatic switch-off unit 307. In one embodiment, the diagnosis unit 303 is used to compare the signal strength of received RF signals with identification codes and determine which signal strength is the strongest. For example, the diagnosis unit 303 would diagnose the signal strength of the closest RF signal source is the strongest. The identification code(s) of the strongest RF signals would then be sent to storage unit 305 to be saved in a database for the next identification procedure. When the corresponding parameters of the identification codes is not received in the preset time, the automatic switch off unit 307 would turn off the 3D glasses automatically.

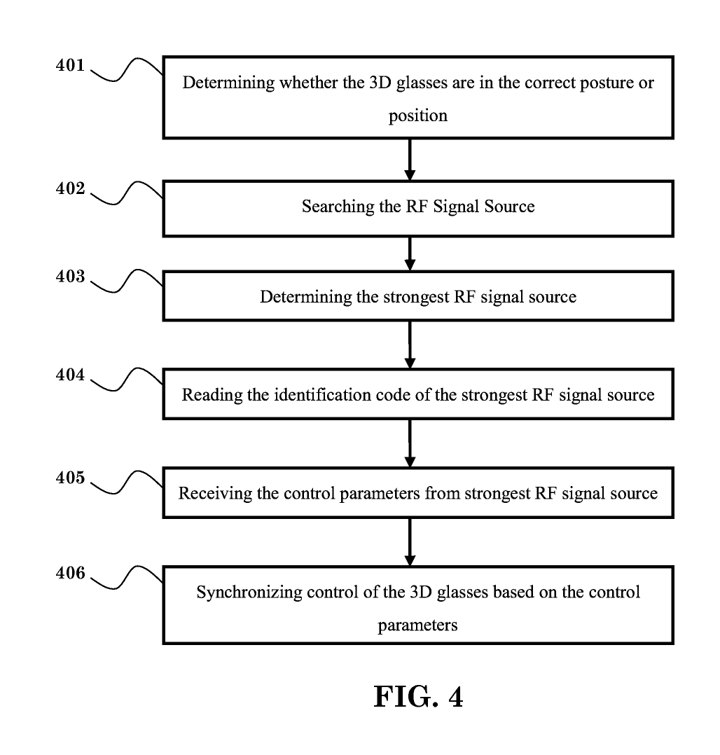

Referring to FIG. 4, this figure is a flowchart that generally outlines RF communication method of the 3D glasses. Step 401 includes the detection of the posture or position of the 3D glasses. If it is determined that the 3D glasses is in the normal (or upright) position (and not in the upside down position), it would be concluded that the 3D glasses is in standby status and that Step 402 should be entered. In Step 402, the signal source is searched. In other words, the 3D glasses search all available 3D signals transmitted from external sources (such as 3D emitters or other 3D equipment), and enter Step 403. Step 403 determines the strongest RF signal source (with identification codes) among all available external 3D signals.

In Step 404, the identification codes of the strongest RF signals are read. In one embodiment, the identification codes of the strongest RF signal would be read first. The storage units 203 and 303 would store the identification codes so that the identification process could be subsequently performed automatically.

In Step 405, the 3D glasses receive 3D control parameters from the emitter as well as other signal sources that emit the strongest RF signals. The 3D control parameters are used to control the process of turning or switching the LCD lenses on/off. In one embodiment, if no parameter is available or received, the 3D glasses could use built-in default parameters. In another embodiment, the 3D glasses would receive the parameters within a preset time interval (e.g., within approximately 10 seconds). In this embodiment, the 3D glasses could be turned off automatically if no parameter is received within the preset time interval.

In Step 406, the 3D glasses are controlled and synchronized according to the control parameters. The controller module 2 of the 3D glasses would control LED lens in the left lens frame 113 and left lens frame 111 and would turn the lenses on/off according to the received parameters to allow users to watch the best 3D effect.

Those of skill in the art would: understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presente.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses Or adaptation of the invention following, in general, the principles of the invention, and including such departures from the present disclosure as come within the known and customary practice within the art to which the invention pertain.

What is claimed is:

1. A method to implement a 3D image system, comprising:
searching and analyzing signals emitted from emitters external to a 3D glasses to determine a strongest RF (Radio Frequency) signal source;
reading and storing an identification code of the strongest RF signal source;
receiving synchronization signals from an emitter that emits the strongest RF signal; and
synchronizing and controlling the 3D glasses based on the synchronization signals.

2. The method of claim 1, further comprising:
determining whether the 3D glasses is in a normal position or an upside down position.

3. The method of claim 1, further comprising:
turning the 3D glasses off upon determining that the 3D glasses is in an upside down position.

4. The method of claim 1, further comprising:
receiving synchronization signals at predetermined intervals.

5. The method of claim 1, wherein, each synchronization signal includes an identification code.

6. The method of claim 5, wherein the identification code includes a manufacturer identification code and a RF identification code.

7. The method of claim 1, wherein each synchronization signal includes an identification code and control parameters.

8. The method of claim 7, further comprising:
turning the 3D glasses off if the control parameters are not received within a preset period of time.

9. The method of claim 7, further comprising:
turning a right lens and a left lens of the 3D glasses on or off based on the control parameters.

10. The method of claim 7, wherein the control parameters includes a waiting time during which the system should wait after receiving a synchronization signal before turning on the right lens.

11. The method of claim 7, wherein the control parameters includes a waiting time during which the system should wait after receiving a synchronization signal before turning off the right lens.

12. The method of claim 6, wherein the control parameters includes a waiting time during which the system should wait after receiving a synchronization signal before turning on the left lens.

13. The method of claim 6, wherein the control parameters includes a waiting time during which the system should wait after receiving a synchronization signal before turning off the left lens.

14. An apparatus to implement 3D imaging, comprising:
a first module to search and analyze signals emitted from emitters external to a 3D glasses to determine a strongest RF (Radio Frequency) signal source;
a second module to read and store an identification code of the strongest RF signal source
a third module to receive synchronization signals from an emitter that emits the strongest RF signal; and
a fourth module to synchronize and control the 3D glasses based on synchronization signals.

15. The apparatus of claim 14, wherein each synchronization signal includes an identification code.

16. The apparatus of claim 15, wherein the identification code includes a manufacturer identification code and a RF identification code.

17. The apparatus of claim 14, wherein each synchronization signal includes an identification code and control parameters.

18. The apparatus of claim 17, wherein the control parameters includes;
a first waiting time during which the system should wait after receiving a synchronization signal before turning on the right lens; and
a second waiting time during which the system should wait after receiving a synchronization signal before turning off the right lens.

19. The apparatus of claim 17, wherein the control parameters includes;
a first waiting time during which the system should wait after receiving a synchronization signal before turning on the left lens; and
a second waiting time during which the system should wait after receiving a synchronization signal before turning off the left lens.
